(19) United States
(12) Patent Application Publication
(10) Pub. No.: US 2014/0345463 A1
(43) Pub. Date: Nov. 27, 2014

(54) ELECTROSTATIC PRECIPITATION APPARATUS FOR ROOM VENTILATION AND VENTILATION SYSTEM INCORPORATING SAME

(71) Applicants: KOUSAKA URATA, Chibaken (JP); TAKESHI KASAHARA, Chibaken (JP)

(72) Inventors: KOUSAKA URATA, Chibaken (JP); TAKESHI KASAHARA, Chibaken (JP)

(73) Assignee: TORNEX INC., Tokyo (JP)

(21) Appl. No.: 14/282,292

(22) Filed: May 20, 2014

(30) Foreign Application Priority Data
May 21, 2013 (JP) 2013-120222

(51) Int. Cl. B03C 3/72

(52) U.S. Cl. CPC B03C 3/72
USPC 96/21

(57) ABSTRACT

The exemplary system/apparatus can include an electrostatic precipitation apparatus for room ventilation, which can have a two-stage charging type electrostatic precipitator including an ionization section, a particle collection section and a power supply. The exemplary apparatus can include a constant-current control unit/arrangement interposed between the power supply and the ionization section. A sensing unit/arrangement can be interposed between the power supply and the particle collection section. A voltage step control unit/arrangement can receive the applied voltage value and current value from the sensing unit/arrangement for issuing a command to increase or decrease the predetermined voltage to prevent the particle collection section from anomalously discharging in response to an anomalous discharge. A voltage changing unit/arrangement can change the predetermined voltage in response to a command from the voltage step control unit to control a current and a voltage provided from the power supply to the particle collection section.

### CROSS-REFERENCE TO RELATED APPLICATION(S)

This application relates to and claims priority from Japanese Patent Application No. 2013-120222, filed on May 21, 2013, the entire disclosure of which is incorporated herein by reference.

### FIELD OF THE DISCLOSURE

The present disclosure relates to an electrostatic precipitation system/apparatus for room ventilation, and more particularly, to an electrostatic precipitation for room ventilation, which can be configured to send a constant current to an ionization section, and apply a particle collection, with a predetermined voltage, in response to the occurrence of an anomalous discharge such as sparking in the dust collection section. The exemplary system/apparatus, according to an exemplary embodiment of the present disclosure can reduce the predetermined voltage to automatically recover from the anomalous discharge, and perform a normal dust collecting action, and in response to the normal dust collecting action sustained for a set time, facilitate the dust collection section to be applied with the predetermined voltage as before the anomalous discharge under the assumption that the cause of the anomalous discharge was eliminated. The present disclosure also relates to a ventilation system/apparatus which can incorporate the electrostatic precipitation apparatus for room ventilation.

### BACKGROUND INFORMATION

Ventilation in rooms can be important in order to keep air in the room hygienic. In business offices, and the like, building management rules can dictate such measures, such as the introduction of fresh and clean external air into offices for keeping employees who work within the offices healthy. In addition to the ventilation in offices, with regard to individual houses, ventilation can be limited only to newly built houses. However, a law reform or ordinance can obligate home owners to take in an external air of a volume equivalent to that of their residences every two hours. However, the external air may not always be clean, and contains dust, pollen, insects and the like. Recently, yellow sand, PM2.5, and the like, have been regarded as problematic. Accordingly, based on building management rules and building standard acts, external air should be introduced into rooms after removing floating particles contained in the external air, such as the aforementioned dust, pollen, insects, yellow sand, PM2.5 and the like.

A filter can be used for removing the above-mentioned substances contained in external air. In the past, mechanical filters having relatively rough meshes have been employed to remove dust, pollen, insects and the like within external air. However, yellow sand, PM2.5, and the like, which can be regarded as problematic in view of health, have particle diameters of approximately 1 μm, and can be so fine that conventional mechanical filters can be incapable of removing them. For this reason, a high-performance mechanical filter having an extremely fine mesh, referred to as a high-efficiency particulate air (“HEPA”) filter, has been employed in increasingly more cases. While the high-performance mechanical filter can be advantageous in its abilities to remove the aforementioned yellow sand, PM2.5, and the like, its fine mesh of the mechanical filter results in a large air flow resistance, and moreover, and can need the removal of floating particles deposit on the mechanical filter in layers to gradually increase the air flow resistance. Thus, a fan can have a relatively high pressure, but can involve gradually increasing power consumption and gradually larger noise. In addition, the amount of external air passing through the mechanical filter could possibly decrease, though gradually, leading to a reduction or a shortage of the needed amount of ventilation.

To solve the foregoing problem(s), an electrostatic precipitation apparatus can be provided for serving as a filter capable of trapping yellow sand, PM2.5, and the like which have the diameter of approximately 1 μm. A ventilation and air-conditioning apparatus intended for persons that have any allergies is known (e.g., JP-2009-36395A), where the electrostatic precipitator can be incorporated for ventilation of a room. As shown in FIG. 6, the electrostatic conventional precipitation apparatus, used in this example, can comprise an ionization section 52, a particle collection section 55, and a power supply 56 for supplying electric power to the ionization section 55 and particle collection section 55. The ionization section can have ionization lines 50 and ionization electrodes 51 for charging floating particles within air, such as dust, pollen, yellow sand, PM2.5, and the like, through corona discharge or the like. The particle collection section 55 comprises particle collection electrode plates 53 and opposing particle collection electrode plates 54, which can alternately be arranged at equal intervals by spacers, in order to trap the charged floating particles with a Coulomb force. The power supply 56 can be configured to supply electric power to the ionization section 52 and dust collection section 55. Then, this electrostatic precipitation apparatus can be used to keep the environment favorable by charging floating particles in the air with the ionization section 52, and collecting the charged floating particles with the particle collection section 55 to remove the floating particles in the air.

Previously, the ionization section 52 and particle collection section 55 were powered from the power supply 56 by methods including a constant-voltage method and a constant-current method. The constant-voltage method can involve applying a constant voltage to the ionization section 52 and particle collection section 55, while the constant-current method can involve applying a constant current to the ionization section 52 while also applying a constant voltage to the particle collection section 55. These power supply methods can be implemented by a control unit 57.

An electrostatic precipitation apparatus which employs the conventional constant-voltage method can suffer from contamination and/or oxidization on the surface of the ionization lines 50 of the ionization section 50 due to floating particle, as the electrostatic precipitation apparatus continues the particle collection. Consequently, a lower current value can be generated by the initially set constant voltage, causing corona discharging to occur with more difficulties, which can result in the particle collection efficiency can be lowered. Moreover, an anomalous discharge, such as sparking, can be caused by the floating particles collected by, and deposited on, the particle collection electrode plates 53 and opposing particle collection electrode plates 54 of the particle collection section 55. Once an anomalous discharge, such as sparking, occurs, the anomalous discharge, such as sparking, can continue unless the application of a high, predetermined, voltage can be stopped from the power supply 56 to the particle collection electrode plates 53 and opposing particle collection electrode plates 54. In the worst case, a fire can occur. As such, the power supply 56 can be prohibited from applying the constant voltage, but as long as the cause of the anomalous discharge can be eliminated, the anomalous discharge such as sparking can immediately follow if the power supply 56 started applying the constant voltage. Thus, the electrostatic precipitation apparatus can remain missing a function of removing floating particles in the air to maintain a favorable environment, which can be expected in the electrostatic precipitation apparatus, while the cause of the anomalous discharge may not be eliminated.

Additionally, the conventional constant-current method may not be affected by corona discharging, or the like, or may not suffer from a lower particle collection efficiency, even if a continuous particle collection can cause the surface of the ionization lines 50 to be contaminated or oxidized by floating particles, because a constant current can be flowing through the ionization lines 50. However, since the particle collection section 55 can likewise be applied with a constant voltage in the constant-current method as well, the conventional constant-current method can be similar to the constant-voltage method in that an anomalous discharge such as sparking can occur due to floating particles collected by and deposited on the particle collection electrode plates 53 and opposing particle collection electrode plates 54 of the particle collection section 55.

To address such problems, a power supply device can be provided for an electrostatic precipitation apparatus. This power supply device can include a power supply arrangement for supplying power to electrodes, a detecting arrangement for detecting a voltage which can be applied to the electrodes when they can be supplied with electric power from the power supply arrangement or detecting an insulation resistance of the electrodes and a determining arrangement for determining whether or not humidity can be attributable to a reduced voltage, or a reduced insulation resistance of the electrodes detected by the detecting arrangement by providing the electrodes with power lower than that supplied by the power supply arrangement, specifically, about 30-100% of the voltage applied by the power supply arrangement and about 1-30% of the current applied by the power supply arrangement. In this manner, the power supply device can determine whether or not a reduced voltage on the electrodes of an associated electrostatic precipitation apparatus should be regarded as a critical case caused by an anomalous discharge, such as sparking, or an immaterial accident caused by humidity or the like, which can be recovered without taking any action therefor. When a critical case can be determined, the power supply arrangement can be instructed to stop supplying the power to the electrodes to prevent the electrostatic precipitation apparatus from damaging, and a maintenance can be performed to remove the cause of the trouble. On the other hand, when an immaterial case can be determined, the power supply arrangement can be facilitated to continue the supply of the power to the electrodes, expecting a spontaneous recovery, so that the electrostatic precipitation apparatus can continue the function of removing floating particles in the air to maintain a favorable environment (for example, see Japanese Patent Publication JP-2008-68207A).

Thus, it may be beneficial to provide an exemplary system/apparatus that can overcome at least some of the deficiencies described herein above.

### SUMMARY OF EXEMPLARY EMBODIMENTS

To address at least such of such issues and/or deficiencies, exemplary system/apparatus, according to an exemplary embodiment of the present disclosure, can be provided that can include an electrostatic precipitation apparatus for room ventilation, which can have a two-stage charging type electrostatic precipitator including an ionization section for charging floating particles in the air, a particle collection section for collecting charged floating particles with a Coulomb force, and a power supply for supplying electric power to the ionization section and the particle collection section. The exemplary apparatus can include a constant-current control unit interposed between the power supply and the ionization section for supplying the ionization section with a constant current which may not cause a predefined voltage to be exceeded. A sensing unit can be interposed between the power supply and the particle collection section for sensing an applied voltage value and current value at all times when the particle collection section can be applied with a predetermined voltage. A voltage step control unit can receive the applied voltage value and current value from the sensing unit for issuing a command to increase or decrease the predetermined voltage to prevent the particle collection section from anomalously discharging in response to an anomalous discharge caused by a sudden fluctuation of the applied voltage value and current value and a continued fluctuation of the applied voltage value and current value within a certain range. A voltage changing unit can change the predetermined voltage in response to a command from the voltage step control unit to control a current and a voltage sent from the power supply to the particle collection section. The ionization section can be applied with a constant current through the constant-current control unit. The particle collection section can be applied with the predetermined voltage through the voltage step control unit. Upon occurrence of an anomalous discharge, the voltage step control unit can stop supplying power to the particle collection section. The voltage changing unit can change the predetermined voltage to a level at which an anomalous discharge does not occur, and the changed predetermined voltage can be applied to the particle collection section to continue a particle collecting action. When the applied voltage value and current value continue to fluctuate within a certain range for a predefined time, a determination can be made that a cause of the anomalous discharge has been eliminated, facilitating the voltage step control unit to issue a command to the voltage changing unit to increase the predetermined voltage. The increased predetermined voltage can be applied to the particle collection section to continue a particle collecting action.

The exemplary electrostatic precipitation system/apparatus for room ventilation can include a voltage step control unit that can operate in a cleaning mode, the cleaning mode can, upon occurrence of an anomalous discharge due to the predetermined voltage applied to the particle collection section, shut off the power supply to the particle collection section with a command from the voltage step control unit, and cause the voltage changing unit to apply a voltage higher than the predetermined voltage to the particle collection section to clean the particle collection section.

The exemplary system/apparatus can also be directed to an electrostatic precipitation apparatus for room ventilation, where the voltage step control unit can output a pulse width modulation signal having a predetermined value from a central processing unit to an amplifier circuit, such that the particle collection section can be applied with the predetermined voltage commensurate with the PWM signal from the voltage changing unit.

In addition, the exemplary system/apparatus can be directed to an electrostatic precipitation apparatus for room ventilation, where the voltage changing unit can include n resistors (R1<R2 . . . <Rn−1<Rn) arranged in parallel between the particle collection section and the power supply. When the sensing unit senses an anomalous discharge while a resistor R1 can be connected between the particle collection section and the power supply, the voltage step control unit issues a command to the voltage changing unit to shut off the particle collection section from the power supply, and subsequently switch the resistor R1 to a resistor R2 having a larger resistance value between the particle collection section and the power supply. The particle collection section can be applied with the predetermined voltage, and the voltage step control unit can subsequently switch (n−2) arranged resistors to resistors R3-Rn having larger resistance values to change, in steps, the predetermined voltage, and apply the changed predetermined voltage to the particle collection section.

Further, the exemplary system/apparatus can be directed to an electrostatic precipitation apparatus for room ventilation, where the voltage changing unit can include n resistors (R1<R2 . . . <Rn−1<Rn) arranged in parallel between the particle collection section and the power supply, when the applied voltage value or current value fluctuate within a certain range for a predefined time while one of the n resistors except for R1 (<R2 . . . <Rn−1<Rn) can be connected between the particle collection section and the power supply, the voltage step control unit can issue a command to the voltage changing unit to shut off the particle collection section from the power supply, and subsequently switch the one resistor to another resistor R1-Rn−1 having a sequentially smaller resistance value between the particle collection section and the power supply to increase the predetermined voltage in steps. The particle collection section can be applied with the predetermined voltage, and can apply the increased predetermined voltage to the particle collection section.

The exemplary system/apparatus can be directed to a ventilation system characterized by utilizing an electrostatic precipitation apparatus for room ventilation as described above.

According to another exemplary embodiment of the present disclosure, the exemplary system/apparatus can use ionization that can be applied with a constant current from the power supply through the constant-current control unit to generate a stable corona discharge, or the like, in the ionization section to charge floating particles in the air which can pass through the ionization section. The particle collection can be applied with a predetermined voltage from the power supply through the voltage step control unit to generate a stable electric field in the particle collection section to trap charged floating particles passing there through. When the sensing unit senses, during the trapping process, sudden fluctuations in the applied voltage value and current value, the particle collection section can be shut off from the power supply by the voltage step control unit on the assumption that an anomalous discharge has occurred in the particle collection section. Then, the voltage changing unit can reduce the predetermined voltage to a level at which an anomalous discharge can be free, and the reduced predetermined voltage can be applied to the particle collection section to continue the particle collecting action. Subsequently, when the sensing unit senses that the applied voltage value and current value in the particle collection section have continued fluctuations within a certain range for a predefined time, the voltage step control unit can determine that the cause of the anomalous discharge has been eliminated, and can shut off the particle collection section from the power supply. Then the voltage changing unit can increase the predetermined voltage, and the increased predetermined voltage can be applied to the particle collection section to continue the particle collecting action. This can be followed by a sequence of the occurrence of anomalous discharge, a temporary shut-off of the anomalous discharge, a reduction of the predetermined voltage, an elimination of anomalous discharge, a continuation of particle collecting action, a continued application of the reduced predetermined voltage for a predefined time, a temporary shut-off of application of the predetermined voltage, and an increase of the predetermined voltage can be performed a particular number of times.

Upon occurrence of an anomalous discharge due to the predetermined voltage applied to the particle collection section, the power supply to the particle collection section can be shut off, the voltage changing unit can apply a voltage higher than the predetermined voltage to the particle collection section to remove substances causing the anomalous discharge from the particle collection section, which can be followed by cleaning the particle collection section.

Upon receipt of anomalous discharge information or anomalous discharge cause elimination information, the voltage step control unit can shut off the particle collection section from the power supply, and then, output a PWM signal having a predetermined value, in accordance with the anomalous discharge information or anomalous discharge cause elimination information from the CPU to the amplifier circuit, such that the particle collection section can be applied with the predetermined voltage commensurate with the PWM signal to continue the particle collecting action. Subsequently, the PWM signal can be modified to decrease or increase the predetermined voltage, in steps, and the resulting predetermined voltage can be applied to the particle collection section to continue a suitable particle collection as well after the occurrence of the anomalous discharge, or after the elimination of the cause of the anomalous discharge.

When the resistor R1 can be connected between the particle collection section and the power supply, the voltage step control unit, which has received the anomalous discharge information from the sensing unit, can shut off the particle collection section from the power supply. Then, the resistor R1 can be switched to a resistor R2 having a larger resistance value between the particle collection section and the power supply, and the resulting predetermined voltage can be applied to the particle collection section to continue the particle collecting action. Subsequently, (n−2) resistors R3-Rn can be sequentially switched from one to another having a next larger resistance value to reduce the predetermined voltage in steps. The resulting predetermined voltage can be applied to the particle collection section to continue the particle collecting action as well after the occurrence of the anomalous discharge.

When the resistor R2 can be connected between the particle collection section and the power supply, the voltage step control unit, which has received the anomalous discharge information from the sensing unit, can shut off the particle collection section from the power supply. Then, the resistor R2 can be switched to a resistor R1 having a smaller resistance value between the particle collection section and the power supply, and the resulting predetermined voltage can be applied to the particle collection section to continue the particle collecting action. Subsequently, (n−2) resistors R3-Rn can be sequentially switched from one to another having a next smaller resistance value to reduce the predetermined voltage in steps. The resulting predetermined voltage can be applied to the particle collection section to continue an even higher particle collecting action after the occurrence of the anomalous discharge.

The exemplary embodiments of the exemplary system/apparatus can stably continue a corona discharge, or the like, in the ionization section, and can reduce the predetermined voltage to promptly resume the formation of a normal electric field to continue a particle collecting action even if an anomalous discharge, such as sparking, occurs due to fluctuations in environment such as humidity. The collected particles can be caused by a continued particle collection, and the like. Once the cause of the anomalous discharge has been eliminated, the applied voltage can be increased to promptly resume the particle collecting action. The particle collecting action can be performed at a high efficiency as a whole against an anomalous discharge due to humidity, or the like, from which the apparatus can be naturally recovered, or from an anomalous discharge due to deposited particles, or the like, from which the apparatus can be naturally recovered. Moreover, the frequency of maintenance can be reduced.

The exemplary system/apparatus can advantageously perform the particle collecting action an even higher efficiency, and can reduce the frequency of maintenance if substances causing an anomalous discharge can be removed from the particle collection section in the cleaning mode.

The voltage step control unit can freely output a PWM signal commensurate with anomalous discharging information in the CPU, such that the particle collection section can be applied with a finer predetermined voltage. Advantageously, a suitable particle collecting action can be continued as well after the occurrence of the anomalous discharge or after the elimination of the cause of the anomalous discharge.

The exemplary voltage step control unit/arrangement can include n resistors arranged in parallel between the particle collection section and the power supply, and a sensing unit for sensing anomalous discharging in the particle collection section. Advantageously, even with a simple configuration, a normal electric field can be promptly formed again, even if an anomalous discharge once occurs such as sparking, thus making it possible to continue an appropriate particle collecting action.

The exemplary voltage step control unit/arrangement can include n resistors arranged in parallel between the particle collection section and the power supply, and the sensing unit for sensing elimination of a cause for an anomalous discharge in the particle collection section. Advantageously, even if an anomalous discharge occurs, such as sparking, a normal electric field can be promptly formed again after eliminating the cause for the anomalous discharge, in spite of a simple configuration, thus making it possible to continue an appropriate particle collecting action.

An exemplary embodiment of a ventilation system can be provided which has the advantages of the electrostatic precipitation apparatus for room ventilation described above.

These and other objects, features and advantages of the exemplary embodiments of the present disclosure will become apparent upon reading the following detailed description of the exemplary embodiments of the present disclosure, when taken in conjunction with the appended claims.

### BRIEF DESCRIPTION OF THE DRAWINGS

Further objects, features and advantages of the present disclosure will become apparent from the following detailed description taken in conjunction with the accompanying Figures showing illustrative embodiments of the present disclosure, in which:

FIG. 1 is an exemplary schematic of an electrostatic precipitation unit in an electrostatic precipitation apparatus for room ventilation according to an exemplary embodiment of the present disclosure;

FIG. 2 is an exemplary circuit diagram of a voltage changing unit of the exemplary electrostatic precipitation apparatus according to an exemplary embodiment of the present disclosure;

FIG. 3 is an exemplary circuit diagram of a further voltage changing unit of the exemplary electrostatic precipitation apparatus according to an exemplary embodiment of the present disclosure;

FIG. 4 is an schematic of a ventilation system which incorporates the exemplary electrostatic precipitation apparatus for room ventilation according to an exemplary embodiment of the present disclosure;

FIG. 5 is an exemplary schematic of a further ventilation system which incorporates the exemplary electrostatic precipitation apparatus for room ventilation according to an exemplary embodiment of the present disclosure; and

FIG. 6 is an exemplary schematic of an electrostatic precipitation unit/arrangement in a conventional electrostatic precipitation apparatus for room ventilation.

Throughout the drawings, the same reference numerals and characters, unless otherwise stated, are used to denote like features, elements, components or portions of the illustrated embodiments. Moreover, while the present disclosure will now be described in detail with reference to the figures, it is done so in connection with the illustrative embodiments and is not limited by the particular embodiments illustrated in the figures and provided in the appended claims.

### DETAILED DESCRIPTION OF EXEMPLARY EMBODIMENTS

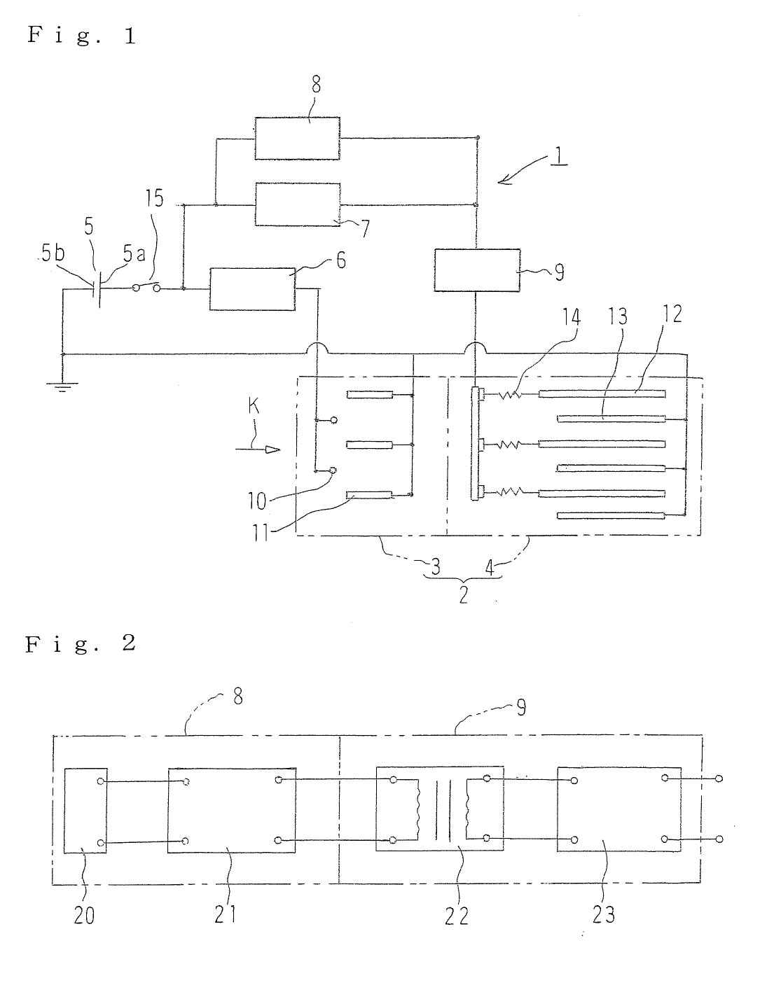

Referring to the drawings, including FIG. 1, an electrostatic precipitation apparatus 1 for room ventilation shown therein can include an electrostatic precipitation unite/arrangement 2. The electrostatic precipitation unit/arrangement 2, which can be referred to as a two-stage charging type, can include an ionization section 3 for charging floating particles in the air, a particle collection section 4 for collecting the charged particles by the action of Coulomb force, and a power supply 5 for supplying electric power to the ionization section 3 and particle collection section 4. The electrostatic precipitation unit/arrangement 2 can also include a constant-current control unit/arrangement 6 which can provide a function of applying the ionization section 3 with a constant current so as not to exceed a set voltage, and a sensing unit 7 for constantly sensing an applied voltage value and current value when the particle collection section 4 can be applied with a predetermined voltage. The electrostatic precipitation unite/arrangement 2/arrangement can further include a voltage step control unit/arrangement 8 which can receive the applied voltage value and current value from the sensing unit 7 for issuing a command to change the predetermined voltage up and down in steps in such a manner that the particle collection section 4 does not suffer from an anomalous discharge due to abrupt fluctuations in the applied voltage value and current value or due to continued fluctuations within a certain range.

The electrostatic precipitation unit/arrangement 2 can further include a voltage changing unit 9 for changing the predetermined voltage up and down in response to the command from the voltage step control unit/arrangement 8. The electrostatic precipitation unite/arrangement 2 can be provided with a function of controlling the current and voltage fed from the power supply 5 to the particle collection section 4. The ionization section 3 can be applied with a constant current from the power supply 5 through the constant-current control unit 6, while the particle collection section 4 can be applied with a predetermined voltage from the power supply through the voltage step control unit/arrangement 8. When the particle collection section 4 suffers from an anomalous discharge, the particle collection section 4 can be shut down from the power supply 5 in response to a command from the voltage step control unit/arrangement 8.

Then, the voltage applied to the particle collection section 4 can be reduced by the voltage changing unit 9 to such a level that does not cause an anomalous discharge, and the particle collection section continues the dust collecting action with the reduced predetermined voltage applied thereto. When the applied voltage value and current value fluctuate within a certain range for a set period of time, the cause of the anomalous discharge can be determined to have been eliminated. Then, the voltage changing unit 9, in response to a command from the voltage step control unit/arrangement 8, can increase, the predetermined voltage which can be applied to the particle collection section 4, thus facilitating the particle collection section 4 to continue the particle collecting action.

The electrostatic precipitation unit/arrangement 2 can be a two-stage charging-type electrostatic precipitation apparatus, and can include the ionization section 3, particle collection section 4, and power supply 5. The electrostatic precipitation apparatus 1 for room ventilation can include the constant-current control unit/arrangement 6 interposed between the power supply 5 and the ionization section 3 within the electrostatic precipitation unite/arrangement 2, and can also include the voltage stage control unit 8, including the sensing unit 7, and voltage changing unit 9 interposed between the power supply 5 and the particle collection section 4.

The ionization section 3 of the electrostatic precipitation unit/arrangement 2 can include ionization lines 10 and ionization electrodes 11 for charging floating particles in the air through corona discharging or the like. The ionization lines 10 can be connected to a plus terminal 5a of the power supply 5, while the ionization electrodes 11 can be connected to a minus terminal 5b of the power supply 5, respectively.

The particle collection section 4 of the electrostatic precipitation unite/arrangement 2 can include particle collection electrode plates 12 and opposing particle collection electrode plates 13 for collecting charged floating particles with the Coulomb force. The particle collection electrode plates 12 and opposing particle collection electrode plates 13 can be alternately arranged at equal intervals by spacers, and can be connected to the power supply 5 such that a high predetermined voltage can be applied between the particle collection electrode plates 12 and opposing particle collection electrode plates 13 to form a high electric field there between. In addition, high resistors 14 can be connected between the respective particle collection electrode plates 12 and the power supply 5. Then, the particle collection electrode plates 12 can be connected to the plus terminal 5a of the power supply 5, while opposing particle collection electrode plates 13 can be connected to the minus terminal 5b of the power supply 5.

The power supply 5 can be provided to supply the ionization section 3 and particle collection section 4 of the electrostatic precipitation unite/arrangement 2 with a voltage and current, and may not be limited in any aspect as long as this condition can be satisfied. As shown in FIG. 1, a switch 15 can be provided for switching on/off the connection between the power supply 5 and the ionization section 3 and particle collection section 4.

The constant-current control unit/arrangement 6 of the power supply control system 1 can be configured to send a constant current from the power supply 5 to the ionization lines 10 of the ionization section 3 at, for example, a constant current in a range of about 0.3 to 2.0 mA. In this event, a proper voltage can be within a range of about 7,000 V to 8,000 V. However, this constant-current control unit/arrangement 6 can include a known function for preventing the voltage from deviating significantly from the range of about 7,000 V to 8,000 V, for example, preventing the voltage from reaching about 10,000 V or more, in order to send a constant current in the range of about 0.3 to 2.0 mA as described above.

The voltage step control unit/arrangement 8 of the power supply control system 1 for room ventilation can be configured to issue a command for applying the particle collection electrode plates 12 of the particle collection section 4 with a predetermined voltage, for example, in a range of about 1,500 V to 4,800 V from the power supply 5. A current associated with this operation can lie in a range of about 0.05 to 0.1 mA. Further, the sensing unit 7 can be configured to sense an anomalous discharge which can introduce abrupt fluctuations in the voltage and current applied to the particle collection section 4. For example, when a normal electric field can be formed by applying the particle collection section 4 with a voltage of about 4,000 V in a normal mode and a current of about 0.1 mA, the sensing unit 4 can sense an anomalous discharge which could cause a sudden change in the environment of the particle collection section 4 for some reason, such as humidity, dew condensation, introduction of foreign matters, and the like, or due to deposition of collected particles and the like, giving rise to abrupt fluctuations in the voltage in a range of about 1,000 to 1,500 V and in the current to about 0.3 mA.

Then, when the sensing unit 7 senses an anomalous discharge as described above in the particle collection section 4, the voltage step control unit/arrangement 8 can receive information indicative of the anomalous discharge. Upon receipt of the anomalous discharge information, the voltage step control unit/arrangement 8 can shut down the particle collection section 4 from the power supply 5 through the switch 15. Then, putting an eye on the fact that the anomalous discharge can be avoided if the predetermined voltage applied to the particle collection section 4 can be reduced, the voltage step control unit/arrangement 8 transmits a command to the voltage changing unit 9 to change the predetermined voltage to such a level at which the anomalous discharge does not occur. The voltage changing unit 9, upon receipt of the voltage changing command, can reduce the predetermined voltage to a level at which the anomalous discharge does not occur, for example, reduces the predetermined voltage by about 900 V to 400 V from about 3,900 V-4,100 V, i.e., to about 3,200 V-3,500 V. Subsequently, when the particle collection section 4 again suffers from an anomalous discharge, the power supply control system 1 copes with the anomalous discharge by further reducing the predetermined voltage in steps in the procedure described above, for example, to about 2,200 V-2,600 V.

Further, the particle collecting action can be continued with the reduced predetermined voltage of about 3,200 V-3,500 V. During the continued particle collecting action, it can be determined that the cause of the anomalous discharge has been eliminated if the voltage value and current value have not presented fluctuations in a certain range, for example, fluctuations reaching to about 1,000 V-1,500 V or about 0.3 mA. Even if such fluctuations have been presented, when the fluctuations of less than five times continue for a predefined time, for example, two-ten minutes, the cause of the anomalous discharge can be determined to be eliminated. Then, the voltage step control unit/arrangement 8 can instruct the voltage changing unit 9 to increase the predetermined voltage to about 3,900 V-4,100 V in the normal mode, which can be applied to the particle collection section 4 to continue the particle collecting action.

When the anomalous discharge occurs, the particle collection section 4 can be shut off from the power supply 5, thus entering the electrostatic precipitation apparatus 1 into a cleaning mode 16. The cleaning mode 16 can focus on the fact that substances causing an anomalous discharge, for example, foreign matters, can be removed by setting the predetermined voltage applied to the particle collection section 4 higher than that applied in a normal particle collecting action, which can result in avoidance of anomalous discharges. For example, the cleaning mode 16 can be added to the voltage step control unit/arrangement 8. When an anomalous discharge occurs with the particle collection section 4 being applied with the predetermined voltage of about 3,900 V-4,100 Vin the normal mode, the power supply to the particle collection section 4 can be stopped by a command issued by the voltage step control unit/arrangement 8. Further, the voltage changing unit 6 can increase the predetermined voltage by about 300 V-500 V from the aforementioned about 3,900 V-4,100 V, for example, to about 4,200 V-4,600 V. This increased voltage can then be applied to the particle collection section 4 for a predefined time, for example, 3-30 seconds to clean the particle collection section 4. After the cleaning is over, the predetermined voltage can be set back to about 3,900 V-4,100 V before the occurrence of the anomalous discharge.

Referring to the change of the predetermined voltage by the voltage step control unit/arrangement 8 and voltage changing unit 9, for example, as shown in FIG. 2, a CPU 20 of the voltage step control unit/arrangement 8, which has received the anomalous discharge information, can compare the received anomalous discharge information with previously stored information, determine a predetermined voltage at a level which may not cause the particle collection section 4 to anomalously discharge, and transmit the resulting voltage changing command to an amplifier circuit 21 in the form of PWM. Then, through the voltage changing unit 9 which can be composed of the amplifier circuit 21, and which has received the PWM signal, a booster transformer 22 and a booster circuit 23, the particle collection section 4 can be applied with a predetermined voltage commensurate with the PWM signal.

Alternatively, the change of the predetermined voltage by the voltage step control unit/arrangement 8 and voltage changing unit 9 can be implemented, for example, as shown in FIG. 3. Specifically, a voltage step control unit/arrangement 8A can issue a command to a voltage changing unit 9A which has n resistors (R1<R2< . . . <Rn−1<Rn) arranged in parallel between the particle collection section 4 and the power supply 5. Then, as the sensing unit 7 senses an anomalous discharge while the resistor R1 is connected between the particle collection section 4 and the power supply 5, the particle collection section 4 can be shut off from the power supply 5 through the switch 15. Next, the resistor R1 can be switched to the resistor R2 having a larger resistance value between the particle collection section 4 and the power supply 5, and thereafter, the particle collection section 4 can be applied with a predetermined voltage at a level at which an anomalous discharge may not occur, facilitating the particle collection section 4 to recover the normal particle collection even after the anomalous discharge. Subsequently, the particle collection section 4 can continue the normal particle collection as long as an anomalous discharge does not occur again. Then, (n−2) resistors R arranged between the particle collection section 4 and the power supply 5 can be sequentially switched to resistors R3-Rn having larger resistance values to change, in steps, the predetermined voltage which can then be applied to the particle collection section 4, thus, facilitating the particle collection section 4 to continue the particle collecting action even after the anomalous discharge. The n resistors R can have resistance values within several MΩ, and can be in the relationship of R1<R2< . . . <Rn−1<Rn. While the resistors R may not be particularly limited in number, three to five resistors can be beneficial.

When the cleaning mode 16 can be added to the voltage step control unit/arrangement 8, a resistor pR having a resistance value lower than that of the resistor R1 (pR<R1), can be provided for the cleaning mode. The particle collection section 4 can be applied with the predetermined voltage of about 3,900 V-4,100 V for the normal mode through the resistor R1. When an anomalous discharge occurs, the power supply can be shut off, the resistor R1 can be switched to the resistor pR, and the predetermined voltage can be increased to about 4,200 V-4,600 V. The particle collection section 4 can be applied with the increased voltage for a predefined time for cleaning the same. Subsequently, the predetermined voltage can again be reduced to about 3,900 V 04,100 V for the normal mode. The resistor pR may not be provided, and one of the n resistors, for example, R1 can be used for the cleaning mode 16, in which case a resistor R2 can be used as a resistor for the normal mode at the onset of particle collection.

The change of the predetermined voltage by the voltage step control unit/arrangement 8 and voltage changing unit 9 can be implemented in the following exemplary manner. A voltage step control unit/arrangement 8A can issue a command to the voltage changing unit 9A which can have n resistors (R1<R2< . . . <Rn−1<Rn) arranged in parallel between the particle collection section 4 and the power supply 5. Then, when the applied voltage value and current value continue to fluctuate for a predefined time within a certain range, as described above, while any of the n resistors except for R1 (R2< . . . <Rn−1<Rn) can be connected between the particle collection section 4 and the power supply 5, the particle collection section 4 can be shut off from the power supply 5. The resistor can be switched to another one having the next smaller resistance value between the particle collection section 4 and the power supply 5, and the resulting predetermined voltage can be applied to the particle collection section 4. Then, (n−2) resistors R arranged between the particle collection section 4 and the power supply 5 can be sequentially switched to resistors R1-Rn−1 having next smaller resistance values to increasingly change in steps the predetermined voltage, which can then be applied to the particle collection section 4.

The exemplary electrostatic precipitation apparatus 1 for room ventilation, can be combined with a heat exchanger 30, and mounted in a building 32 as a ventilation system 31. Specifically, the exemplary electrostatic precipitation apparatus 1 for room ventilation can be mounted near an air supply port 33 of the building 32, and can be connected to an inlet port 35 of a room 34 through the heat exchanger 30. The room 34 can have an outlet port 36 connected to an air discharge port 37 of the building 32 through the heat exchanger 30. Then, external air entering from the air supply port 33 of the building 32 by the action of an air supply fan 39 connected between the heat exchanger 30 and the air discharge port 37, can be purified by the electrostatic precipitation apparatus 1 for room ventilation, and can be introduced into the room 34 from the inlet port 35 as heated or cooled fresh air. Stagnant air within the room 34 can go out from the outlet port 36 by the action of a ventilation fan 39 connected between the heat exchanger 30 and air discharge port 37, it can exit through the heat exchanger 30 to heat or cool external air which has entered from the air supply port 33. The stagnant air itself can be cooled or heated, and can exit from the air discharge port 37 of the building 32.

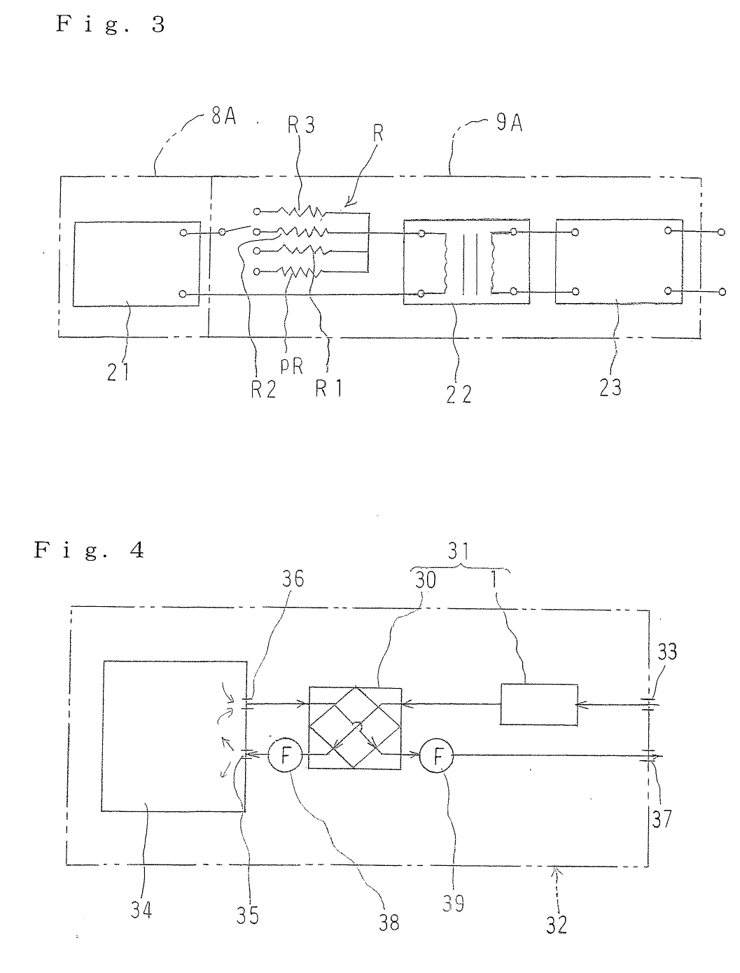

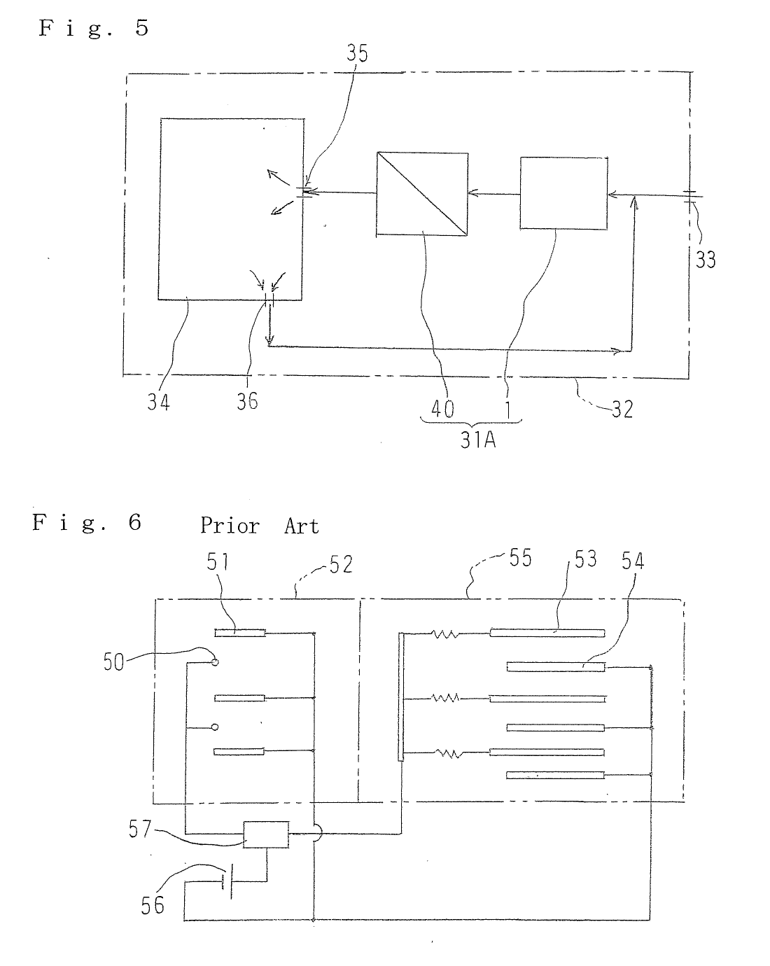

The exemplary electrostatic precipitation apparatus 1 for room ventilation can be combined, for example, with an air conditioner 40, instead of the heat exchanger, as shown in FIG. 5, and can be mounted in a building 32 for use as a ventilation system 32A. Since the rest of the configuration and actions in FIG. 5 can be similar to those of the ventilation system 31 shown in FIG. 4, similar elements in FIG. 5 can be designated by the same reference numerals used in FIG. 4. Stagnant air within the room can be entirely or partially returned to the electrostatic precipitation apparatus 1 for room ventilation after it goes out from the outlet port 36.

In order to facilitate use of the exemplary system/apparatus, the ventilation system 21 or 21A can be made operative, and the power supply 5 of the electrostatic precipitation apparatus 1 can be turned ON. In this state, external air supplied from the air supply port 33 of the building 32 enters into the ionization section 3 of the electrostatic precipitation unite/arrangement 2 from a direction indicated by an arrow K in FIG. 1. The floating particles in the air, such as dust, pollen, insects, yellow sand, PM2.5, and the like, can be charged through a corona discharge, or the like, which can be present between the ionization lines 10 and the ionization electrodes 11 in the ionization section 3. Then, due to contamination on and/or oxidization of the surfaces of the ionization lines 10, and the like, associated with a continuous operation of the electrostatic precipitation unite/arrangement 2, the corona discharge can stably occur with more difficulties unless a higher voltage can be applied to the electrostatic precipitation unite/arrangement 2 than the initially applied voltage.

However, the ionization lines 10 of the ionization section 3 can be applied with a constant current, for example, a constant current in a range of about 0.3 to 2.0 mA from the power supply 5 through the constant-current control unit 6, such that even if the ionization lines 10 can be contaminated, oxidized, or the like on the surface, the initially applied voltage can be effectively changed to a higher voltage, facilitating the corona discharge to occur with stability. Accordingly, the ionization section 3 can be free from degradations when charging floating particles, and therefore can be free from degradations in particle collection efficiency due to such influences as contamination, oxidization, and the like on the surfaces of the ionization lines 10.

As the air, including the charged floating particles, enters into the particle collection section 4, the charged floating particles can be collected by a plurality of particle collection electrode plates 12 or opposing particle collection electrode plates 13 with the Coulomb force by a high electric field which can be generated by applying a predetermined voltage, for example, about 3,900 V-4,100 V for the normal mode, between a plurality of particle collection electrode plates 12, and a plurality of opposing particle collection electrode plates 13 of the particle collection section 4. Clean air can be emitted from the particle collection section 4 after the particle collection. When an anomalous discharge such as sparking occurs due to a varying environment between a plurality of particle collection electrode plates 12 or opposing particle collection electrode plates 13, possibly caused by humidity, dew condensation, foreign matters, deposited floating particles, or the like, a high electric field cannot be maintained between a plurality of particle collection electrode plates 12 and a plurality of opposing particle collection electrode plates 13, or a predetermined voltage cannot evenly be applied thereto.

However, the voltage step control unit/arrangement 8 and voltage changing unit 9 stop the predetermined voltage applied from the power supply 5 to the plurality of particle collection electrode plates 12 of the particle collection section 4, and subsequently reduce the predetermined voltage in steps to about 3,200 V-3,500 V and further to about 2,200 V-2,600 V to eliminate the anomalous discharge, and then generate a high electric field again. As such, even after the anomalous discharge occurs between a plurality of particle collection electrode plates 12, and a plurality of opposing particle collection electrode plates 13, the particle collecting action can be continued, though the particle collection efficiency can be slightly lowered due to the reduction in the predetermined voltage applied to the particle collection section 4, thus making it possible to extend a period between maintenances for washing the particle collection section 4, and the like.

With the cleaning mode 16 added to the voltage step control unit/arrangement 8 as described above, when the particle collection section 4 can be applied with the predetermined voltage of about 3,900 V-4,100 V for the normal mode, the cleaning mode 16 can cause the predetermined voltage to be increased by about 300 V-500 V, for example, to 4,200 V-4,600 V. The increased predetermined voltage can then be applied to the particle collection section 4 for a predefined time to clean the same. Subsequently, the predetermined voltage can be set back to about 3,900 V-4,100 V as before the occurrence of the anomalous discharge. In another case, if an anomalous discharge occurs when the particle collection section 4 can be applied with the predetermined voltage of about 3,200 V-3,500 V, the predetermined voltage can be increased to the original about 3,900 V-4,100 V, which can be applied to the particle collection section 4 for a predefined time to clean the same. Subsequently, the predetermined voltage can be set back to about 3,900 V-4,100 V as before the occurrence of the anomalous discharge. Likewise, the particle collection section 4 can be cleaned in the same manner when it can be applied with the predetermined voltage of about 2,200 V-2,600 V.

Based on the above, e.g., external air, from which floating particles have been removed, such as dust, pollen and insects, yellow sand and PM2.5, and the like, can enter from the inlet port 35 into the room 34 through the heat exchanger 30 as cooled or heated purified fresh air when the ventilation system 31 can be implemented as shown in FIG. 4. On the other hand, stagnant air within the room 34 exits from the outlet port 36 of the room 34, passes through the heat exchanger 30 to heat or cool external air entering from the air supply port 33, and exits to the outside from the air discharge port 37 of the building 32. When the ventilation system 31A can be implemented as shown in FIG. 5, external air, from which floating particles have been removed, can be conditioned by the air conditioner 40 to become fresh air which can enter into the room 34. Stagnant air within the room 34 exits from the room 34, again enters the air conditioner 40, and can be conditioned thereby to be fresh air which enters into the room 34.

### EXEMPLARY INDUSTRIAL AVAILABILITY

The exemplary electrostatic precipitation apparatus for room ventilation and the ventilation system according to the present disclosure can stably continue corona discharge, or the like, in an ionization section, and can promptly resume the application of a normal voltage to continue a particle collecting action even if an anomalous discharge, such as sparking, occurs. Accordingly, the exemplary electrostatic precipitation apparatus and the ventilation system can provide an extremely high availability when the particle collecting action can be degraded due to humidity, dew condensation, and the like and can be naturally recovered. When foreign matters or collected particles can be readily removed by a simple cleaning operation, the application of a normal voltage at a higher level can be promptly resumed to facilitate the particle collection section to continue the particle collecting action, thus improving a particle collection efficiency as a whole, and enhancing the availability of the electrostatic precipitation apparatus when a reduction in the frequency of maintenance can be beneficial.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures which, although not explicitly shown or described herein, embody the principles of the disclosure and can be thus within the spirit and scope of the disclosure. Various different exemplary embodiments can be used together with one another, as well as interchangeably therewith, as should be understood by those having ordinary skill in the art. In addition, certain terms used in the present disclosure, including the specification, drawings and claims thereof, can be used synonymously in certain instances, including, but not limited to, for example, data and information. It should be understood that, while these words, and/or other words that can be synonymous to one another, can be used synonymously herein, that there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

What is claimed is:

1. An electrostatic precipitation apparatus for a room ventilation, comprising:
a two-stage charging type electrostatic precipitator including:
a) an ionization section configured to charge floating particles in the air,
b) a particle collection section for collecting charged floating particles with a coulomb force, and
c) a power supply for supplying electric power to the ionization section and the particle collection section;
a constant-current control arrangement located between the power supply and the ionization section, and configured to supply the ionization section with a constant current that prevents a predetermined voltage to be reached;
a sensing arrangement located between the power supply and the particle collection section, and configured to sense an applied voltage value and a current value when the particle collection section is applied with a predefined voltage;
a voltage step control arrangement configured to receive the applied voltage value and the current value from the sensing arrangement, to issue a command to at least one of increase or decrease the predefined voltage to prevent the particle collection section from anomalously discharging in response to an anomalous discharge caused by at least one of (i) a sudden fluctuation of the applied voltage value, (ii) the current value, (iii) a continued fluctuation of the applied voltage value, or (iv) the current value within a particular range; and
a voltage changing arrangement configured to change the predetermined voltage in response to a command from the voltage step control arrangement to control a current and a voltage provided from the power supply to the particle collection section,
wherein the ionization section is applied with a constant current through the current control arrangement, the particle collection section is applied with the predetermined voltage through the voltage step control arrangement, and upon an occurrence of an anomalous discharge, the voltage step control arrangement stops supplying power to the particle collection section;
the voltage changing arrangement is configured to change the predetermined voltage to a level at which an anomalous discharge does not occur, and the changed predetermined voltage applied to the particle collection section continues a particle collecting action; and
when the applied voltage value and current value continue to fluctuate within a certain range for a predefined time, a determination is made that a cause of the anomalous discharge has been eliminated, facilitating the voltage step control arrangement to issue a command to the voltage changing unit to increase the predetermined voltage, the increased predetermined voltage being applied to the particle collection section to continue the particle collecting action.

2. The electrostatic precipitation apparatus according to claim 1, wherein the voltage step control arrangement operates in a cleaning mode, the cleaning mode including, upon occurrence of an anomalous discharge due to the predetermined voltage applied to the particle collection section, when shutting off the power supply to the particle collection section with a command from the voltage step control arrangement, causing the voltage changing arrangement to apply a voltage higher than the predetermined voltage to the particle collection section to clean the particle collection section.

3. The electrostatic precipitation apparatus according to claim 1, wherein the voltage step control arrangement is configured to output a pulse width modulation (PWM) signal having a predetermined value from a central processing unit (CPU) to an amplifier circuit such that the particle collection section is applied with the predetermined voltage commensurate with the PWM signal from the voltage changing arrangement.

4. The electrostatic precipitation apparatus according to claim 1,
wherein the voltage changing arrangement includes a plurality of resistors arranged in parallel between the particle collection section and the power supply, and when the sensing arrangement senses an anomalous discharge while a first resistor is connected between the particle collection section and the power supply, the voltage step control arrangement is configured to issue a command to the voltage changing arrangement to shut off the particle collection section from the power supply and switch the first resistor to a second resistor having a larger resistance value between the particle collection section and the power supply, the particle collection section being applied with the predetermined voltage, and
wherein the voltage step control arrangement is configured to switch a first set of resistors to a second set of resistors having larger resistance values in order to change the predetermined voltage in steps, and apply the changed predetermined voltage to the particle collection section.

5. The electrostatic precipitation apparatus according to claim 2,
wherein the voltage changing arrangement includes a plurality of resistors arranged in parallel between the particle collection section and the power supply, and when the sensing arrangement senses an anomalous discharge while a first resistor is connected between the particle collection section and the power supply, the voltage step control arrangement is configured to issue a command to the voltage changing arrangement to shut off the particle collection section from the power supply and switch the first resistor to a second resistor having a larger resistance value between the particle collection section and the power supply, the particle collection section being applied with the predetermined voltage, and
wherein the voltage step control arrangement is configured to switch a first set of resistors to a second set of resistors having larger resistance values in order to change the predetermined voltage in steps, and apply the changed predetermined voltage to the particle collection section.

6. The electrostatic precipitation apparatus according to claim 1, wherein the voltage changing arrangement includes a plurality of resistors arranged in parallel between the particle collection section and the power supply, and when at least one of the applied voltage value or the current value fluctuate within a certain range for a predefined time while a first resistor is connected between the particle collection section and the power supply, the voltage step control arrangement is configured to issue a command to the voltage changing arrangement to shut off the particle collection section from the power supply, and subsequently switches the first resistor to a second resistor having a sequentially smaller resistance value between the particle collection section and the power supply to increase the predetermined voltage in steps, and wherein the particle collection section is applied with the predetermined voltage, and applies the increased predetermined voltage to the particle collection section.

7. The electrostatic precipitation apparatus for room ventilation according to claim 2,
wherein the voltage changing arrangement includes a plurality of resistors arranged in parallel between the particle collection section and the power supply, and when at least one of the applied voltage value or the current value fluctuate within a certain range for a predefined time while a first resistor is connected between the particle collection section and the power supply, the voltage step control unit is configured to issue a command to the voltage changing unit to shut off the particle collection section from the power supply, and subsequently switches the first resistor to a second resistor having a sequentially smaller resistance value between the particle collection section and the power supply to increase the predetermined voltage in steps, and
wherein the particle collection section is applied with the predetermined voltage, and applies the increased predetermined voltage to the particle collection section.

8. A ventilation system comprising
an electrostatic precipitation apparatus for room ventilation according to claim 1.

9. A ventilation system comprising
an electrostatic precipitation apparatus for room ventilation according to claim 2.

10. A ventilation system comprising
an electrostatic precipitation apparatus for room ventilation according to claim 3.

11. A ventilation system comprising
an electrostatic precipitation apparatus for room ventilation according to claim 4.

12. A ventilation system comprising
an electrostatic precipitation apparatus for room ventilation according to claim 6.
